(19) United States
(12) Patent Application Publication
(10) Pub. No.: US 2018/0341350 A1
(43) Pub. Date: Nov. 29, 2018

(54) INTEGRATED CONTROL PANEL APPARATUS AND USE THEREOF

(71) Applicant: Methode Electronics, Inc., Chicago, IL (US)

(72) Inventors: Ron SHPAKOFF, Southfield, MI (US); Robert SCHMIDT, Livonia, MI (US); Tim GREEN, Holly, MI (US); Ernie PACSAI, Wixom, MI (US); James CITTA, Southfield, MI (US)

(21) Appl. No.: 15/829,430

(22) Filed: Dec. 1, 2017

Related U.S. Application Data
(60) Provisional application No. 62/429,296, filed on Dec. 2, 2016.

(51) Int. Cl. G06F 3/044; G06F 3/041; G06F 1/16; B60K 37/06

(52) U.S. Cl. CPC G06F 3/044; G06F 3/0414; G06F 1/1643; B60K 2350/1028; B60K 37/06; G06F 2203/04112; G06F 1/1652

(57) ABSTRACT

An integrated control panel for use in a motor vehicle/automobile, which includes a stack assembly and associated electronics modules for processing signals. The assembly includes one or more capacitive sensors between a decorative touch surface layer and a movable member. Between the movable member and a stationary member is a gap in which a plurality of metallic devices outputting a magnetic flux are positioned across from respective induction sensors. Supporting the movable member above the stationary member are flexible members that compress upon application of a force (touch) on the surface layer, which permits the distance separating the metallic devices and inductions sensors to decrease in a manner that is measurable. The electronics modules provide touch location and force information, which may be conveyed to the motor vehicle/automobile electronics.

### CROSS REFERENCE TO RELATED APPLICATIONS

This is a nonprovisional application that claims priority to and the benefit of U.S. Provisional Application No. 62/429,296, filed Dec. 2, 2016, entitled “Integrated Control Panel Apparatus and Use Thereof,” the content and disclosure of which are incorporated herein by reference.

### FIELD OF INVENTION

The present invention relates to integrated control panels (ICP) useful in providing an interface between a vehicle passenger and the functions of the vehicle, and uses of the integrated control panels. More particularly, the present invention relates to integrated control panels employed in automobiles.

### DESCRIPTION OF RELATED ART

Automobiles often have many, separate, and different mechanical interface devices. It may be convenient to the driver and passenger to simplify and enhance these devices by consolidating them into fewer such devices, or even as part of a single aggregate instrument that can relay commands to vehicle control devices. Such aggregate instruments may include a touch control panel, or touchscreen, that integrates the functions of multiple interface devices.

Automotive integrated control panels, also referred to as Electronic Finish Panels (EFP), are used in automobiles to communicate information to passengers, receive commands from passengers, and control various functions of the automobile, among other purposes. integrated control panels are available with or without displays, and may employ switches, toggles, knobs, and/or touchscreens, among other devices, to allow for user interaction with the functions of the automobile via the integrated control panels. By using an integrated control panels, the driver or passenger can adjust several different devices by interacting with a hierarchical menu shown through the integrated control panel's touch panel from an underlying display to select a particular device and to select a particular function associated with that device.

Capacitive sensing has been used to identify both a location of an applied force to a surface, and the relative degree of the force being applied.

### SUMMARY AND OBJECTS OF THE INVENTION

In one aspect of the invention, an integrated control panel is provided having a touch screen surrounded or flanked on the left and right sides with touch areas that are activated by pressing a finger to the surface of the touch areas.

In another aspect of the invention, an integrated control panel is provided without the need for a display or a touch screen.

In still another aspect of the invention, inductive sensing is used in combination with a mechanical flex frame to determine a force being transmitted.

Another aspect of the invention is the use of inductive sensing in combination with an integrated control panel mechanical flex frame to determine a touch location on a touch area.

In another aspect of the invention, inductive sensing is used in combination with a mechanical flex frame and capacitive sensing to determine both touch force and location.

In still another aspect of the invention, one or more accelerometers may be used to compensate for the relative movement of the integrated control panel assembly, such as the movement of the integrated control panel installed in a moving automobile/vehicle.

In yet another aspect of the invention, a software subsystem having various modules for providing various functions of the integrated control panel, is provided.

In another aspect of the invention, an electrical wiring harness and/or other electronic interface is provided, whereby the electrical harness/interface provides connectivity between the integrated control panel and the host automobile's/vehicle's other electronic systems.

U.S. Pat. No. 8,976,012 (Methode Electronics, Inc., Chicago, Ill.), which is incorporated in its entirety herein by reference, describes one solution for using flexible members in an integrated control panel-like assembly. The '012 patent describes an assembly having a panel adapted to be mated to a vehicle, a frame placed around and spaced apart from the panel, at least one flexible coupling to connect the panel to the frame, a haptic actuator connected to the frame and the panel, an input device mated to the frame, and a display connected to the panel so as to be stationary with respect to the panel. The panel includes one or more cutouts extending into the panel, and the frame includes one or more extensions extending away from the frame. The one or more extensions are received by a respective one of the one or more cutouts. The at least one flexible coupling includes a loop. The input device is adapted to cause movement of the frame when an input is received, and the display is placed under the input device.

U.S. Pat. No. 8,169,306 (Methode Electronics, Inc., Chicago, Ill.), which is incorporated in its entirety herein by reference, describes additional ways to detect the transmission of touch forces from a surface to other components. The '306 patent describes a device with haptic effects. The system includes a first surface, a second surface with a flexible arm portion, a coupling that couples the flexible arm portion to the first surface, and a haptic effect generator attached to the first surface. The flexible arm portion includes a coupling portion, and the coupling is received in the coupling portion. The haptic effect generator causes movement of the first surface relative to the second surface, and the flexible arm limits the movement of the first surface and elastically returns the first surface substantially to its original position relative to the second surface.

Based on the foregoing, it is observed that a new and improved technique for employing integrated control panels in vehicles/automobiles is needed. The present invention meets the requirements of a low cost, operationally simple device, which is not complex to assemble, and which outputs reliable signals of a valid touch by a user.

### BRIEF DESCRIPTION OF THE DRAWINGS

FIG. 1 is a schematic diagram of an integrated control panel according to one aspect of the invention.

FIG. 2A is a partial cross-sectional schematic block diagram depicting a stack of components that make up an integrated control panel according to one aspect of the invention.

FIG. 2B is a partial perspective exploded view of some of the components of an integrated control panel according to another aspect of the invention.

FIG. 3 is a schematic diagram of an integrated control panel and its electronics modules according to one aspect of the invention.

FIG. 4 is a process flow diagram according to one aspect of the invention.

### DETAILED DESCRIPTION OF THE PREFERRED EMBODIMENT

Several preferred embodiments of the invention are described for illustrative purposes, it being understood that the invention may be embodied in other forms not specifically described below and/or shown in the drawings.

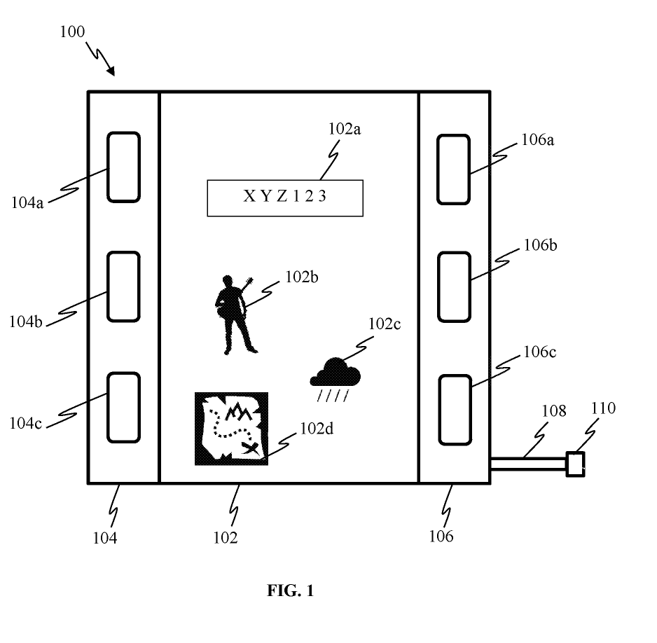

Turning first to FIG. 1, shown therein is a schematic diagram of an integrated control panel 100 according to one aspect of the present invention. The integrated control panel 100 shown includes a display portion 102, a left-side touch area 104, a right-side touch area 106, and an electrical wiring harness and connector 108.

As shown, the display 102 may provide (that is, output, visually convey, display, etc.) information to the vehicle passenger (hereinafter “user”), such as in the form of textual information 102a, meta-data related to a music selection 102b, weather graphics and information 102c, and map-based driving graphics, instructions, and information 102d, among other types and forms of content.

The left-side touch area 104 may display one or more icons 104a, 104b, . . . 104n (where n is the number of desired icons). These icons identify portions of the left-side touch area 104 where a user may touch to select a function (that is, input a command that causes a function to initiate, including providing one or more of the aforementioned content). In the embodiment shown, the left-side touch area 104 is configured with a home icon (104a), a telephone icon (104b), and a screen input selector icon (104c), but other icons for other functions may be displayed instead. Moreover, the various available different icons may be made to be displayed such as by swiping, along a portion of the left-side touch area 104 from the top to bottom of the left-side touch area 104, such that the icons “scroll” from one position to another.

Similarly, the right-side touch area 106 may display one or more icons 106a, 106b, . . . 106m (where m is the number of desired icons). These icons identify portions of the right-side touch area 106 where a user may touch to select a function (that is, input a command that causes a function to initiate, as described above). In the embodiment shown, the right-side touch area 106 is configured with a “tools” icon (106a), a brightness-increase icon (106b), and a brightness-decrease icon (106c), but other icons for other functions may be displayed instead, and may also be made to be displayed by swiping from the top to bottom of the right-side touch area 106, as also described above.

The electrical wiring harness and connector 108 provides electrical connectivity between the integrated control panel 100 and the vehicle's/automobile's power source and electrical systems, and may terminate with an industry-standard or customized multi-pin connector 110.

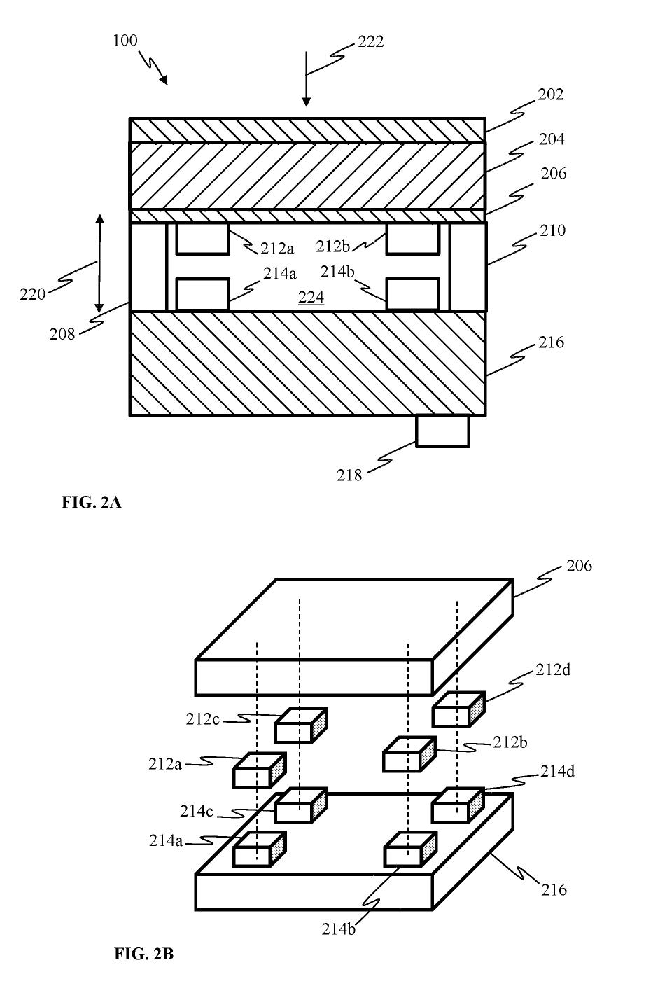

Turning now to FIG. 2A, shown therein is a partial cross-sectional schematic block diagram depicting a stack of components that make up an integrated control panel 100 according to one aspect of the invention. The stack includes at least the following, listed in order from top to bottom, left to right:
A decorative surface 202 at the top;
An array of capacitive sensor electrodes 204 below the decorative surface 202 (depicted schematically as a single block instead of individual sensors);
A movable member 206 below the electrodes 204;
A gap 224; and
A stationary member 216 below the gap 224;

The stack also includes at least the following positioned at least partially within the gap 224:
A left-side flexible member 208 connecting between the bottom or other portion of the movable member 206 and the top or other portion of the stationary member 216;
Spaced apart metal targets 212a, 212b (only two shown; more could be used) attached to the bottom side of the movable member 206 and extending into the gap 224 space;
A right-side flexible member 210 connecting between the bottom or other portion of the movable member 206 and the top or other portion of the stationary member 216; and
Spaced apart inductive sensors 214a, 214b (only two shown; more could be used) attached to the bottom side of the movable member 206 and extending into the gap 224 space, each one approximately aligned with a corresponding metal target 212a, 212b above it.

In one aspect, the decorative surface 202, the array of capacitive sensor electrodes 204, and the movable member 206 may constitute certain of the components of the display 102, as shown in FIG. 1. In another aspect, the decorative surface 202, the array of capacitive sensor electrodes 204, the movable member 206, and the stationary member 216 may constitute certain of the components of the display 102.

The decorative surface 202 may be, for example, a sheet of glare-reducing flat or curved glass that forms the portion of the integrated control panel 100 that the user is able to see and touch. The decorative surface 202 may be addressed to output or display or convey the left-side and right-side touch area icons 104a, 104b, . . . , 104n, 106a, 106b, . . . , 106m and the display 102a . . . 102d information, either on the top surface, on the bottom surface, or within the decorative surface 202 material. The decorative surface 202 may also be used to output the information as noted in connection with the description of FIG. 1 above.

The array of capacitive sensor electrodes 204, which are well known in the art, are positioned adjacent to and below the decorative surface 202, and may extend across the entire functional surface or in discrete locations of the functional surface of the bottom side of the decorative surface 202 or the top side of the movable member 206. There may be a single electrode, multiple electrodes, or a matrix of electrodes. The electrodes align with the aforementioned icons that are visible to the user, as discussed above and shown in FIG. 1.

The movable member 206 may be a structural device that supports (transmits) a force when the decorated surface 202 is touched by the user. The arrow 220 indicates the relative movement in the vertical or z-axis of the group of stack components that are collectively above the gap 224 (i.e., 202, 204, and 206) relative to the stationary member 216 below the gap 224. This movement may be caused by, for example, an external force (user's figure touch) applied to the top surface of the decorative surface 202, as indicated by arrow 222.

The left-side flexible member 208 and right-side flexible member 210 are structural devices that expand (flex) and contract (give) when the user touches (pushes) on the movable member 206 by way of touching the top surface of the decorative surface 202. The expansion and contraction of the flexible members 208, 210, respectively, changes the distance between the movable member 206 and the stationary member 216.

In FIG. 2A, the metal targets 212a, 212b, which may be made from ferrous or non-ferrous material, interact with the respective magnetic fields created by the inductive sensors 214a, 214b. Each of the inductive sensors 214a, 214b may be, for example, a coil that inductively interacts with the corresponding metal targets 212a, 212b that are opposite the inductive sensors 214a, 214b. Suitable inductive sensors include those made by Texas Instruments Semiconductor. In operation, the inductance of the coil will change in response to the distance change between the movable member 206 and the stationary member 216 when the user pushes on the movable member 206.

As shown in FIG. 2B, in one embodiment of the invention, four inductive sensors 214a, 214b, 214c, 214d are used (arranged approximately near the four corners of the movable member 206, and four metal targets 212a, 212b, 212c, 212d are used (arranged generally opposite the inductive sensors 214a, 214b, 214c, 214d, i.e., one in each corner of the movable member 206. The positioning of the four inductive sensors 214a, 214b, 214c, 214d, could correspond approximately to locations below where the left-side and right-side touch area icons 104a, 104c, 106a, 106c, are displayed (assuming, in this case, just those found icons are displayed to the user). For example, the left-side touch area icon 104c (bottom left corner), the metal target 212a, and the inductive sensor 214a could be generally aligned together in the vertical/z-axis direction.

The stationary member 216 provides the base for the integrated control panel 100. Most of the mass of the assembled components is supported by the stationary member 216. It may be located and mounted to the vehicle's instrument panel structure (not shown).

Also shown in FIG. 2A is an acceleration reference sensor 218 connected to the bottom side of the stationary member 216. The acceleration reference sensor 218 is used to detect when the integrated control panel 100 assembly, or portions thereof, are being subject to an applied force due to, for example, vibration transmitted to the integrated control panel 100 from the vehicle. Thus, the acceleration reference sensor 218 may output x-y-z-axis reference movement parameters indicative of the relative movement of the integrated control panel 100 mounted in a moving vehicle/automobile with respect to the individual components of the integrated control panel 100, such as the decorative surface 202, the array of capacitive sensor electrodes 204, and the movable member 206.

The size of the various components depicted in FIG. 2 are not shown to scale; in fact, the components may vary depending on the use case for the integrated control panel 100. FIG. 2 shows only the cross-section in the x-z plane, but one skilled in the art would appreciate that the stack components also may extend into/out of the page in the y-direction, and the size of the components may vary in that direction also depending on the particular application of the integrated control panel 100.

Each of the individual stack components may themselves be made up of different components. For example, the left-side and right-side flexible members 208, 210 may each be made up of several individual flexible members arranged along a left or right edge of the movable member 206 and stationary member 216, or they could extend around the entire periphery of the gap 224.

It will be apparent that other components could be added to the stack that add functionality to the integrated control panel 100, but at the same time do not detract from the basic function of the integrated control panel 100 as described and shown in the various embodiments. For example, FIG. 2 does not depict the components of the integrated control panel 100 integrated into (attached to) a suitable frame and/or housing that integrates with the host vehicle aesthetically and functionally, or the mounting and/or attachment devices for mounting/attaching the integrated control panel 100 to the frame/housing or to the vehicle/automobile. FIG. 2 also does not depict adhesives or other substances or mechanical devices for connecting the stack components to each other. Other additional components that could be added to the stack could address preferences of a customer for whom a particular integrated control panel 100 is produced.

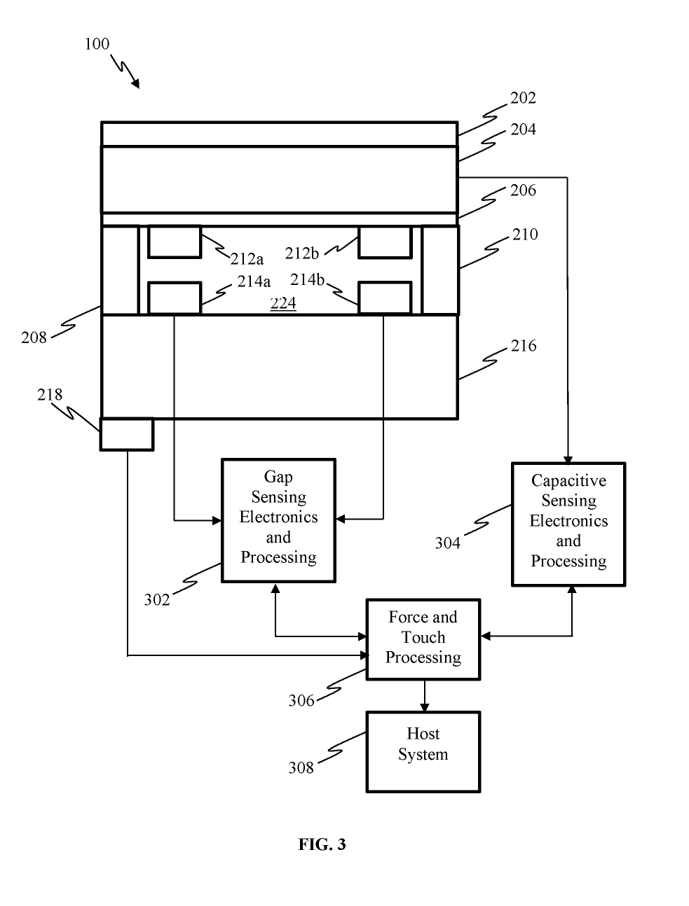

Turning now to FIG. 3, shown therein is a schematic diagram of an integrated control panel 100 and its electronics modules according to one aspect of the invention. One of the modules shown is a gap sensing electronics and processing module 302. Also shown is a capacitive sensing electronics and processing module 304, a force and touch processing module 306, and a host system 308.

The gap sensing electronics and processing module 220 includes the electronics that energize the inductive sensors 214 and outputs signals indicative of a change in the inductance of the coils when the metal targets 212 moves in relation to the inductive sensors 214.

The capacitive sensing electronics module 222 includes the logic circuits necessary to determine where, by reference to the movable member 206, the user is touching on the decorative surface 202.

The force and touch processing module 224 includes the logic circuits and software to combine the forces associated with a user touching the decorative surface 202 with the capacitive touch signal from the capacitive sensing electronics module 222 to provide one output signal via the electrical wiring and power connector 108 (or a different signal carrying device) to the host system 226 (e.g., a signal containing force and position information).

The host system 226 uses the signal to perform a particular function. In the case of FIG. 1, for example, the host system 226 provides the function of furnishing information for display on the display 102.

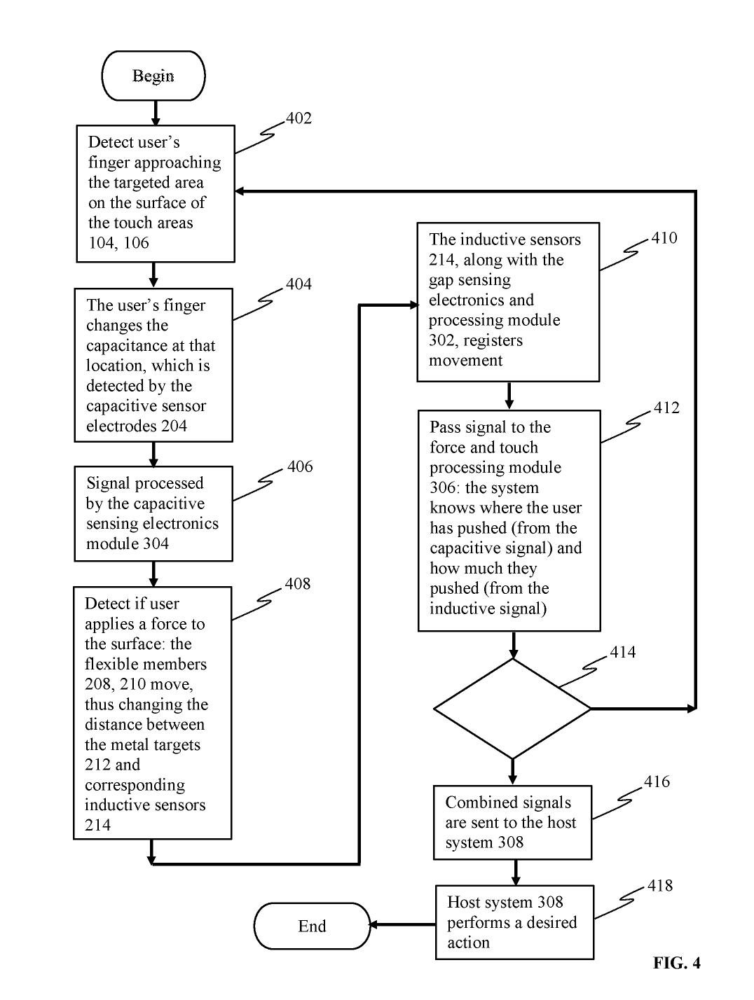

Turning now to FIG. 4, shown therein is a process flow diagram according to one aspect of the invention. In step 402, the integrated control panel 100 detects as the user's finger approaches a specific targeted area on the surface of either the left- and right-side touch areas 104, 106, as illustrated by arrow 222 in FIG. 2A. For example, the system may detect when a user's figure approaches one of the icons 104a, 104b, . . . 104n, or icons 106a, 106b, . . . 106m.

In step 404, the user's finger changes the capacitance at the location where the user's figure approaches the targeted area. This change is detected by one or more of the capacitive sensor electrodes in the array of capacitive sensor electrodes 204, which causes the one or more capacitive sensor electrodes to output a signal to the capacitive sensing electronics and processing module 304.

In step 406, the output signal received by the capacitive sensing electronics and processing module 304 is then processed, and a signal may be outputted to the force and touch processing module 306 containing information indicative of one or more of the targeted area and the specific one of the icons 104a, 104b, . . . 104n, or icons 106a, 106b, . . . 106m. The capacitive sensing electronics of the integrated control panel 100 can reject noise by employing particular algorithms, such that, for example, no output signal is sent when a physical movement is detected that might appear to be similar to a user's finger approaching the target area but is in fact not such as action.

In step 408, as the user applies a force to the surface of the decorative surface 202 using his or her finger, the force is transferred down the stack of the integrated control panel 100 and causes the one or more of the flexible members, such as the left-side and right-side flexible members 208, 210, to be in a compressive state position relative to its nominal state position (each flexible member may end up at a different compressive state, depending on where the user's figure applies the force). The difference between the nominal and compressive states is reflected as a change in the distance, that is the gap 224 separating the bottom surface of the movable member 206 and the top surface of the stationary member 216 (the distance may be different at different positions across the gap, again depending on where the user's figure applies the force). Reducing the gap distance also changes the distance between the one or more of the metal targets 212 and their corresponding inductive sensors 214. For example, with reference to FIG. 2B, as the user's applied force is transmitted to the stack, the distance separating inductive sensor 214a and its corresponding metal target 212a may be different than the separation distance between the inductive sensor 214b and its corresponding metal target 212b, and both of those separation distances may be different that the distances between the inductive sensors 214c, 214d and their corresponding metal targets 212c, 212d, respectively.

The change in the gap distance between pairs of respective inductive sensors 214 and metal targets 212 affects the degree to which the magnetic flux emanating from the metal targets 212 is sensed by the inductive sensors 214. Generally, the closer the magnetic flux is the inductive sensors 214, the greater the inducement of a current in the inductive sensors 214, which could be a linear response and is measurable.

In step 410, the individual inductive sensors 214, along with the gap sensing electronics and processing module 302, registers the movement of the stack components of the integrated control panel 100 thus described. The gap sensing electronics and processing module 302 can reject certain magnetic flux noise by employing a particular algorithm and the use of additional magnetic flux sensors (no shown) to account for nearby and ambient magnetic flux sources that might otherwise interfere with the sensing function of the individual inductive sensors 214.

In step 412, the signal outputted by the gap sensing electronics and processing module 302 is then passed to the force and touch processing module 306. In doing so, a determination of where the user has pushed on the decorative surface 202 (i.e., the capacitive signal) and the relative amount the user has pushed (i.e., the inductive signal), is made. One skilled in the art will appreciate that the applied force location on the decorative surface 202 may also be determined by inductive sensing alone, specifically by monitoring and comparing the output signals from each of the inductive sensors 214a, 214b, 214c, 214d.

In decision step 414, the individual and combined capacitive and inductive signals include information that may be compared to certain criteria for assessing a valid push. As part of this comparison, information from the acceleration reference sensor (accelerometer) 218 may be used to provide an input to the algorithms to assess vibrational noise that may contribute to the signals outputted by the inductive sensors 214a, 214b, 214c, 214d. If the user's touching the decorative display 202 is assessed and determined not to be a valid push, the process returns to step 402 and waits to detect a user's finger approaching the left-side and right-side touch areas 104, 106. But if the touch is determined to be a valid push, the force and touch processing module 306 sends a signal to the host system 308 containing information useful to the host system 308 so that it may initiate an action responsive to the user's touch.

Finally, in step 418, the host system 308 actually initiates and performs the desired action initiated by the user's finger. This action may be, for example, downloading content and causing it to be displayed to the user.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

We claim:

1. An assembly adapted to being integrated in a host vehicle, comprising:
a touch surface for receiving an applied force;
at least one capacitive sensor electrode adjacent the touch surface for outputting a signal indicative of an addressable location on the touch surface;
a movable member adjacent the at least one capacitive sensor electrode for transmitting the applied force;
a stationary member disposed opposite the movable member and separated therefrom by a pre-determined gap;
a plurality of flexible members connected to the movable member and the stationary member and extending therebetween across the pre-determined gap such that transmission of the applied force causes one or more of the plurality of flexible members to be compressed, to extend, or to remain static compared to their state prior to the applied force;
at least two metal targets each connected to the movable member at a position that is proximate to one of the plurality of flexible members, wherein each of the at least two metal targets outputs a respective magnetic flux; and
at least two inductive sensors corresponding to each of the at least two metal targets for outputting a signal indicative of the respective magnetic flux, wherein each of the at least two inductive sensors comprises an induction coil, and wherein the at least two inductive sensors are connected to the stationary member at a position that is proximate to the at least two of the plurality of flexible members and opposite the corresponding at least two metal targets.

2. The assembly of claim 1, further comprising a gap sensing electronics and processing module adapted to outputting a first signal indicative of the degree of the applied force.

3. The assembly of claim 1, further comprising a capacitive sensing electronics module adapted to outputting a signal indicative of the location of the applied force.

4. The assembly of claim 1, further comprising a force and touch processing module adapted to outputting a signal containing information indicative of the location of the applied force and the degree of the applied force.

5. The assembly of claim 1 further comprising a frame dispose around at least some of the assembly or a housing for enclosing at least some of the assembly, wherein the frame or housing is integrated with the vehicle.

6. The assembly of claim 1, further comprising an acceleration reference sensor connected to the stationary member for outputting a signal containing information useful in determining a vibrational state of the assembly.

7. The assembly of claim 1, further comprising a decorative surface coupled to the assembly such that it is adjacent to the array of capacitive sensor electrodes on a side of the array opposite to the side that is adjacent to the movable member.

8. The assembly of claim 1, wherein the signal containing information indicative of the location and the applied force is useful in causing the vehicle to provide information to the user.

9. A method for processing information about a touch applied to an assembly in a host vehicle comprising:
providing a touch surface for receiving an applied force;
outputting, by at least one capacitive sensor electrode adjacent the touch surface, a signal indicative of an addressable location on the touch surface;
transmitting, by a movable member adjacent the at least one capacitive sensor electrode, the applied force;
transmitting, by a plurality of flexible members connected to the movable member and a stationary member and extending therebetween across a pre-determined gap, the applied force such that the flexible members are compressed, extended, or remaining static compared to a state prior to the applied force;
outputting, from each of at least two metal targets connected to the movable member at a position that is proximate to one of the plurality of flexible members, a magnetic flux; and
outputting, by at least two inductive sensors corresponding to each of the at least two metal targets, a signal indicative of the respective magnetic flux, wherein each of the at least two inductive sensors comprises an induction coil, and wherein the at least two inductive sensors are connected to the stationary member at a position that is proximate to the at least two of the plurality of flexible members and opposite the corresponding at least two metal targets.

10. The method according to claim 9, further comprising determining an object approaching the touch surface by monitoring the capacitance of the at least one capacitive sensor electrode.

11. The method according to claim 9, further comprising determining a relative change in the separation gap between the at least two metal targets and corresponding ones of the at least two inductive sensors.

12. The method according to claim 9, further comprising outputting a signal to the host system containing information useful in responding to the applied force.

13. An electronics module for an integrated control panel of a host vehicle comprising:
a gap sensing electronics and processing module adapted to outputting a first signal indicative of a degree of an applied force to a touch surface;
a capacitive sensing electronics module adapted to outputting a second signal indicative of a location of the applied force on the touch surface; and
a force and touch processing module adapted to outputting a third signal containing information indicative of the location of the applied force and a degree of the applied force useful by the host vehicle in responding to the applied force.

14. The electronics module according to claim 13, wherein the gap sensing electronics and processing module is connected to at least two inductive sensors.

15. The electronics module according to claim 13, wherein the capacitive sensing electronics module is connected to at least one capacitive sensor electrode adjacent the touch surface.
